(19) United States
(12) Patent Application Publication
(10) Pub. No.: US 2010/0148708 A1
(43) Pub. Date: Jun. 17, 2010

(54) VOLTAGE SCALING OF AN ELECTRIC MOTOR LOAD TO REDUCE POWER CONSUMPTION

(76) Inventors: Joel A. Jorgenson, Fargo, ND (US); Jonathan P. Kotta, Fargo, ND (US); Michael J. Schmitz, Fargo, ND (US); Gregory M. Middlestead, Fargo, ND (US); Jamie G. Cochran, Fargo, ND (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/333,114

(22) Filed: Dec. 11, 2008

(51) Int. Cl. H02P 27/00; H02M 7/44

(52) U.S. Cl. 318/400.3; 363/79

(57) ABSTRACT

Embodiments of an apparatus to increase the power efficiency of an electric motor load have been presented. In one embodiment, the apparatus includes a parameter detection circuit coupled to the electric motor load to detect one or more parameters of the electric motor load. Furthermore, the apparatus may include a power management controller coupled to the parameter detection circuit to receive the one or more parameters and to scale a voltage supply to the electric motor load in response to the parameters.

### TECHNICAL FIELD

The present invention relates generally to power management, and in particular to methods and systems to improve the power efficiency of electric motor loads.

### BACKGROUND

Conventionally, a hard drive in many computing systems is powered by a constant voltage. FIG. 1 illustrates a typical conventional system 100. The system 100 includes a hard drive 160, a fixed voltage regulator 120, and a host controller 140. The host controller 140 is coupled to a data port 166 of the hard drive 160 to send data to and/or receive data from the hard drive 160. The fixed voltage regulator 120 is coupled to a power port 164 of the hard drive 160 to supply a constant voltage to the hard drive 160. Typically, the constant voltage is at a value greater than or equal to the nominal voltage required by the hard drive 160. During operation, the fixed voltage regulator 120 supplies the same constant voltage to the hard drive 160 regardless of the actual power demand of the hard drive 160.

However, the conventional system 100 may be undesirable for many applications. Although a fixed supply voltage may be easy to implement in many applications, the power efficiency of the system 100 is generally low because of the constant voltage supply.

### BRIEF DESCRIPTION OF THE DRAWINGS

The present invention is illustrated by way of example, and not of limitation, in the figures of the accompanying drawings in which:

FIG. 1 illustrates a system level diagram for one conventional electrical system;

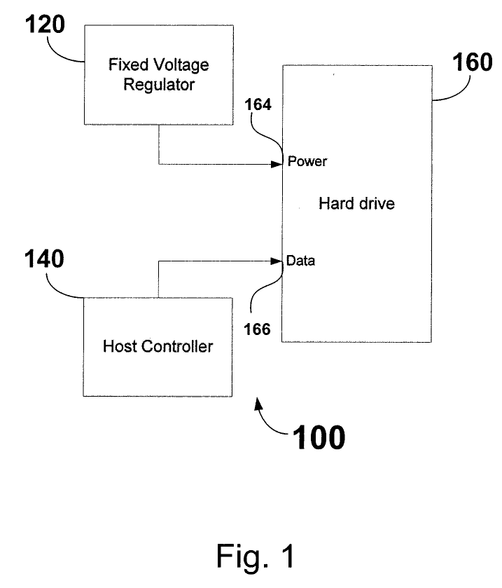

FIG. 2 illustrates an embodiment of a system for voltage scaling of an electric motor load to reduce power consumption;

FIG. 3 illustrates an embodiment of a system for voltage scaling of a hard drive to reduce power consumption;

FIG. 4 illustrates a second embodiment of a system for voltage scaling of a hard drive to reduce power consumption;

FIG. 5 illustrates a third embodiment of a system for voltage scaling of a hard drive to reduce power consumption;

FIG. 6 illustrates an embodiment of a threshold comparator to determine when the current draw of the hard drive exceeds a programmable threshold;

FIG. 7 illustrates a state machine according to an embodiment of the present invention;

FIG. 8 illustrates a second state machine according to an embodiment of the present invention; and

FIG. 9 illustrates a timing diagram for a state machine according to an embodiment of the present invention.

### DETAILED DESCRIPTION

The following embodiments of the invention relate to a system and an apparatus to increase the power efficiency of an electric motor load. More specifically, embodiments of the present invention relate to a system and an apparatus to dynamically adjust a power supply in accordance with the power requirements of an electric motor load in order to improve the overall power efficiency of the system.

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention.

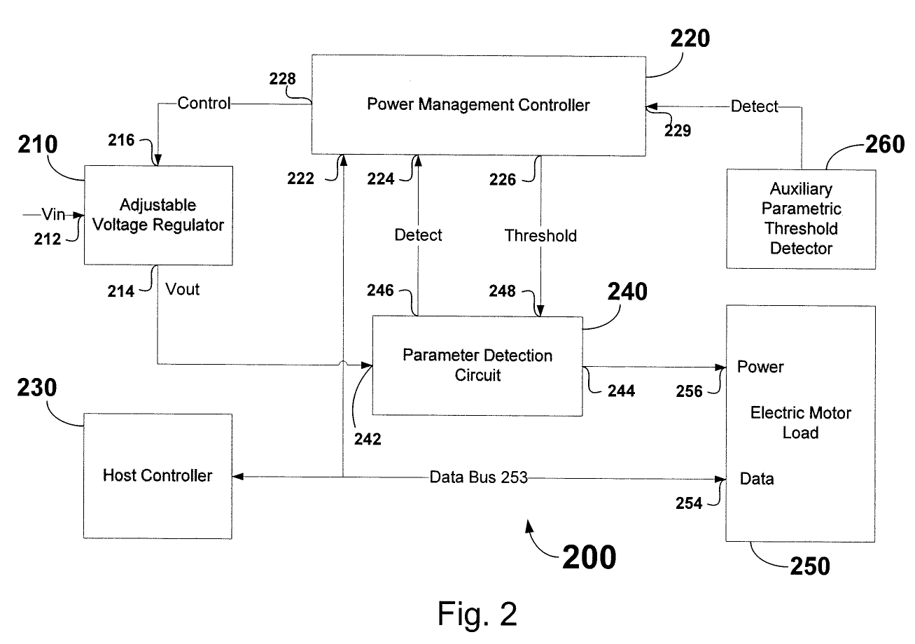

FIG. 2 illustrates one embodiment of a system 200 for voltage scaling of an electric motor load 250. The system 200 includes an adjustable voltage regulator 210 (hereinafter “AVR 210”), a host controller 230, a power management controller 220 (hereinafter “PMC 220”), a parameter detection circuit 240, an electric motor load 250, and an auxiliary parametric threshold detector 260. The PMC 220 includes a data port 222, a parameter detection input 224, a threshold output 226, a control output 228, and an auxiliary parameter detection input 229. The electric motor load 250 includes a data port 254 and a power input 256. The parameter detection circuit 240 includes a power input 242, a power output 244, a detect output 246 and a threshold input 248. The AVR 210 includes a voltage input 212, an adjustable voltage output 214, and a control input 216.

In some embodiments, the electric motor load 250 includes a hard drive, such as a magnetic hard drive, an optical hard drive, etc. Alternatively, the electric motor load 250 may include various types of actuators, a propulsion system, various motors, or any electrical or motorized device in other embodiments. In one embodiment, the magnetic hard drive includes a spindle, which holds one or more flat circular disks called platters to hold recorded data. Each of the platters may be spun at a high rate of speed within a very close distance to read-and-write heads of the hard drive, which can detect and modify the magnetization of the material directly under it. An actuator arm may reposition the heads away from the platter when, for example, a read or write event is not taking place. This repositioning is referred to as the loading or unloading of the heads. In some embodiments where the electric motor load 250 includes a hard drive, the host controller 230 may include a memory controller or a central processing unit.

The parameter detection circuit 240 may be located inside or outside of the electric motor load 250. In some embodiments, the parameter detection circuit 240 may be part of the AVR 210. Alternatively, the parameter detection circuit 240 may be on the same IC (integrated circuit) as the PMC 220, or on a separate IC as the PMC 220. Furthermore, the PMC 220 may be located inside or outside of the electric motor load 250. The AVR 210 may be located inside or outside of the electric motor load 250 or on the same or separate IC as the PMC 220. Other physical locations of the parameter detection circuit 240, the AVR 210, and the PMC 220 may be utilized.

Referring to FIG. 2, the control output 228 of the PMC 220 is connected to the control input 216 of the AVR 210. The adjustable output voltage 214 of the AVR 210 is connected to the power input 242 of the parameter detection circuit 240. The auxiliary parametric threshold detector 260 is connected to the auxiliary parameter detection input 229 of the PMC 220. The parameter detection circuit 240 is in bidirectional communication with the PMC 220. The PMC 220 receives detect signals from the detect output 246 of the parameter detection circuit 240 and sends threshold signals from the threshold output 226 to the threshold input 248 of the parameter detection circuit 240. The power output 244 of the parameter detection circuit 240 is connected to the power input 256 of the electric motor load 250. The data port 254 of the electric motor load 250, the host controller 230, and the data port 222 of the PMC 220 are all connected to the data bus 253. The host controller 230 is in bidirectional communication with the electric motor load 250 through the data bus 253. The PMC 220 monitors the communication on the data bus 253 through the data bus interface at data port 222.

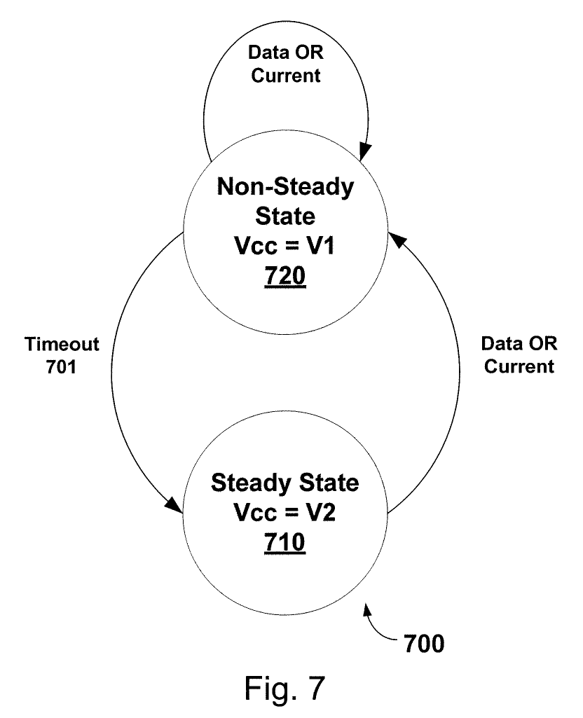

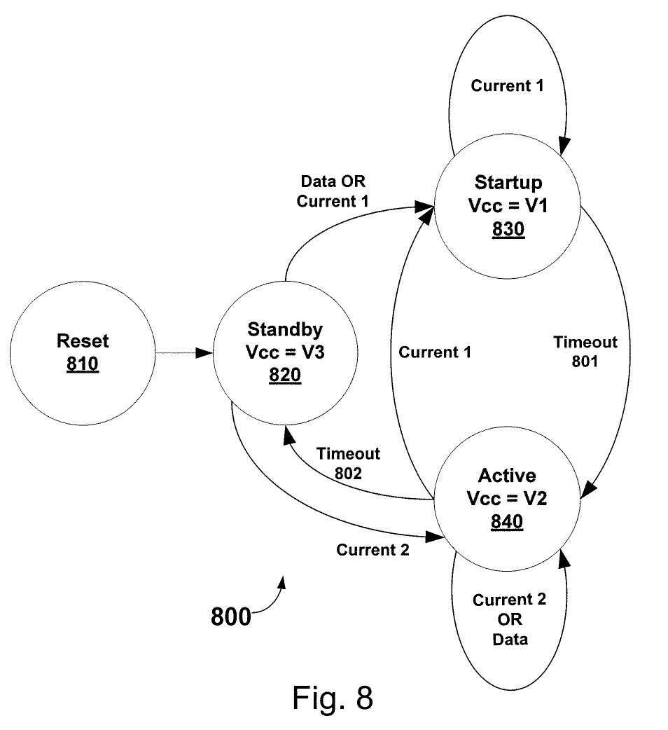

In one embodiment, the PMC 220 implements a power management state machine (some embodiments of which are discussed later with reference to FIGS. 7-8) that determines the appropriate input supply voltage for the electric motor load 250 depending on the detected activity of the electric motor load 250 and causes the AVR 210 to dynamically adjust the output voltage 214 connected to the power input 256 of the electric load 250 through the parameter detection circuit 240. Dynamically adjusting the input voltage to the electric motor load 250 may improve the overall power efficiency of the system 100 because the electric motor load 250 has multiple modes of operation with different power requirements. The PMC 220 controls the output voltage 214 of the AVR 210 that supplies power to the electric motor load 250 to reduce the total power consumption of the electric motor load 250. The PMC 220 controls the mode of operation of the AVR 210 based on one or more parameters detected, such as the electrical current drawn by the electric motor load 250, communication on the data bus 253, operating temperature of the electric load 250, etc. In some embodiments, the AVR 210 may operate in one or more modes, such as a switching regulator in PWM (pulse width modulation) mode, a switching regulator in PFM (pulse frequency modulation) mode, and a LDO (low dropout DC linear voltage regulator) mode, for example. In summary, the PMC 220 dynamically adjusts the voltage output 214 of the AVR 210 to accommodate the power requirements of the electric motor load 250 to improve power efficiency.

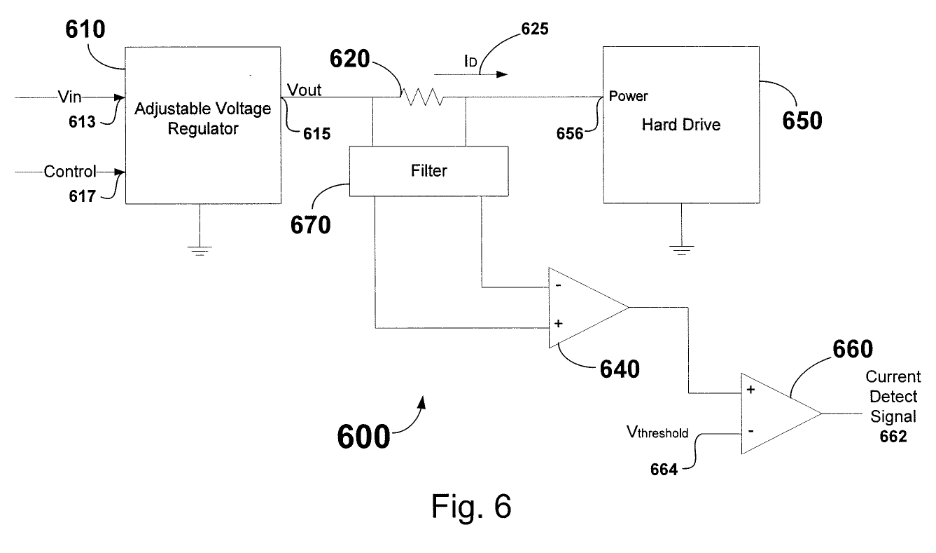

In some embodiments, the power input 242 of the parameter detection circuit 240 (hereinafter “PDC 240”) receives power from the AVR 210 and forwards the power through the power output 244 to the power input 256 of the electric motor load 250. In one embodiment, the PDC 240 includes a threshold comparator. Alternatively, other parameter detection devices may be used. A threshold comparator is used to determine when a parametric value exceeds a programmable threshold 248, which is provided by the PMC 220. In one embodiment, the PDC 240 receives the threshold data from the PMC 220 to be used as a reference value for the comparator of PDC 240, which is further discussed below with reference to FIG. 6. In one embodiment, the PDC 240 detects a parameter associated with the power received from the AVR 210, compares the parameter to the programmable threshold 248 received from the PMC 220, and delivers the result to the parameter detection input 224 of the PMC 220. The parameter detected by the PDC 240 may be at least one of several parameters, such as electrical current, voltage potential, etc. The detected parameters received from the PDC 240 allows the PMC 220 to determine what state of operation the electric motor load 250 is in. Based on the state of operation, the PMC 220 may dynamically adjust the output voltage 214 of the AVR 210 to accommodate that particular state of operation in a more power efficient manner. For example, in a state that requires a lower voltage supply, the PMC 220 may cause the AVR 210 to lower the voltage supply to the electric motor load 250. When the electric motor load 250 transitions to a state that requires a higher voltage supply, the PMC 220 may cause the AVR 210 to increase the voltage supply to the electric motor load 250. Some embodiments of the process to dynamically adjust power supply to the electric motor load 250 are discussed in detail below.

In one embodiment, the host controller 230 of FIG. 2 controls and communicates with the electric motor load 250 through the data bus 253 For example, the electric motor load 250 may have several different modes of operation, each with different power requirements. This, in turn, demands different voltage outputs from the AVR 210. The PMC 220 may dynamically adjust the output voltage 214 of the AVR 210 based on the communication monitored at the data port 222 on the PMC 220. For example, the PMC 220 may monitor the communication between the host controller 230 and the electric motor load 250 to identify the different commands from the host controller 230 that cause the electric motor load 250 to enter different modes of operation. Communications between the host controller 230 and the electric motor load 250 may include toggling of a chip select, rising or falling edges of a digital I/O line interfacing the electric motor load 250 to the host controller 230, and specific commands and data sent between the host controller 230 and the electric motor load 250, etc. Such communication may be decoded by the PMC 220 to determine if a particular event requires the PMC 220 to adjust the voltage delivered to the electric motor load 250 by the AVR 210. The PMC 220 may then dynamically adjust the output voltage 214 of the AVR 210 to more efficiently accommodate the voltage requirement of each state with a more power efficient voltage setting.

In one embodiment, the auxiliary parametric threshold detector 260 (hereinafter “APTD 260”) of FIG. 2 also detects one or more additional parameters. The PMC 220 may dynamically control the AVR 210 output voltage based on the additional parameters detected by the APTD 260. For example, the APTD 260 may detect the temperature of the electric motor load 250. As different modes of operation may change the operating temperature of the electric motor load 250, the temperature of the electric motor load 250 may be indicative of the current mode of operation of the electric motor load 250. The APTD 260 sends temperature measurements to the PMC 220, which then determines the current mode of operation of the electric motor load 250. The appropriate output voltage 214 of the AVR 210 to accommodate the mode of operation of the electric motor load 250 is then selected to improve power efficiency.

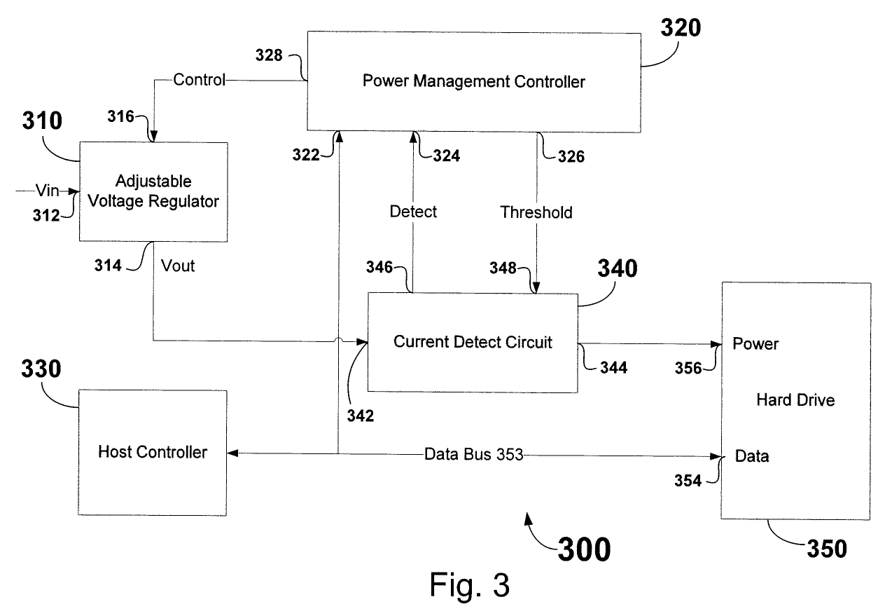

FIG. 3 illustrates one embodiment of a system 300 for voltage scaling of a hard drive 350. The system 300 includes a host controller 330, an adjustable voltage regulator (AVR) 310, a power management controller (PMC) 320, a current detect circuit 340, and the hard drive 350. The current detect circuit 340 includes a power input 342, a power output 344, a detect output 346 and a threshold input 348. The hard drive 350 includes a data port 354 and a power input 356. The hard drive 350 may use contemporary storage technology including magnetic or optical architectures. The PMC 320 includes a parameter detection input 324, a threshold output 326, and a control output 328. The AVR 310 includes a voltage input 312, an adjustable voltage output 314, and a control input 316.

In one embodiment, the PMC 320 sends one or more control signals to the control input 316 of the AVR 310 via the control output 328 and threshold data to the threshold input 348 of the current detect circuit 340 via the threshold output 326. The AVR 310 sends an output voltage 314 to the input power 342 of the current detect circuit 340, which forwards the output voltage to the power port 356 of the hard drive 350 via the power output 344. The current detect circuit 340 sends one or more detect signals to the parameter detection input 324 of the PMC 320 via the detect output 346. The hard drive 350 and the host controller 330 are in bidirectional communication with each other via the data bus 353, where the PMC 320 is also coupled to the data bus 353 via the data port 322 to monitor communication on the data bus 353.

In some embodiments, the current detect circuit 340 includes a filter to screen out noise on the power lines. Many mechanisms may be incorporated to introduce noise filters where there is no appreciable delay added to the valid detection of current.

In one embodiment, the programmable threshold of the current detect circuit 340, which is further discussed below with reference to FIG. 6, is set such that the current draw of the hard drive 350 associated with spinning up the platters, accessing the patters, and unloading the heads of the hard drive 350 is greater than the current threshold associated with the threshold reference voltage 348. Furthermore, other hard drive operating states such as active, idle, standby, and sleep may draw less current than the current associated with the threshold reference voltage 348.

The current detect circuit 340 may be located inside or outside of the hard drive 350. In some embodiments, the current detect circuit 340 may be part of the AVR 310. Alternatively, the current detect circuit 340 may be on the same IC as the PMC 320, or on a separate IC as the PMC 320. Furthermore, the PMC 320 may be located inside or outside of the hard drive 350. The AVR 310 may be located inside or outside of the hard drive 350 or on the same or separate IC as the PMC 320. Other physical locations of the current detect circuit 340, the AVR 310, and the PMC 320 may be utilized.

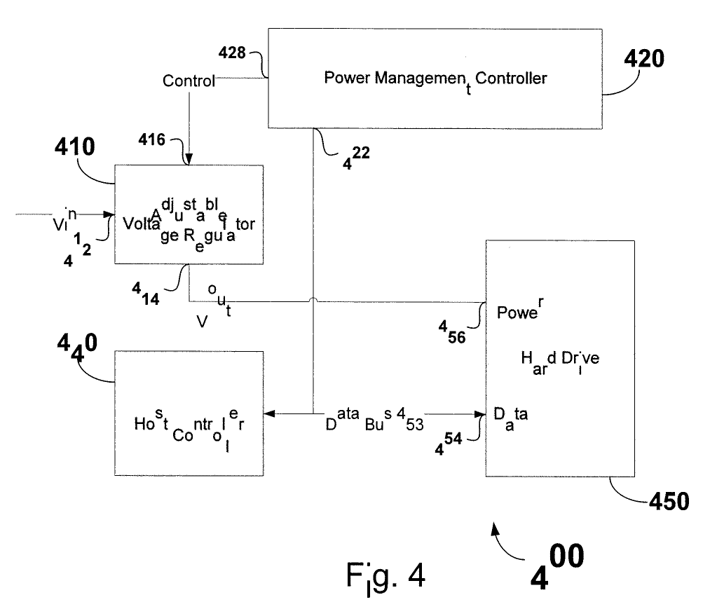

FIG. 4 illustrates one embodiment of a system 400 for voltage scaling of a hard drive 450. The system 400 includes a host controller 440, an adjustable voltage regulator (AVR) 410, a power management controller (PMC) 420, and a hard drive 450. The hard drive 450 includes a data port 454 and a power input 456. The PMC 420 includes a data input 422, and a control output 428. The AVR 410 includes a voltage input 412, an adjustable voltage output 414, and a control input 416.

The AVR 410 may be located inside or outside of the hard drive 450 or on the same or separate IC as the PMC 420. Likewise, the PMC 420 may be located inside or outside of the hard drive 450. Other physical locations of the AVR 410 and the PMC 420 may be utilized in different embodiments.

In one embodiment, the control output 428 of the PMC 420 is connected to the control input 416 of the AVR 410. The adjustable output voltage 414 of the AVR 410 is connected to the power input 456 of the hard drive 450. The hard drive 450 and the host controller 440 are in bidirectional communication with each other via the data bus 453, where the PMC 420 is also coupled to the data bus 453 via the data port 422 to monitor communication on the data bus 453.

In one embodiment, the host controller 440 sends control and communication signals to the data port 454 of hard drive 450 to control the hard drive 450. The PMC 420 detects these control and communication signals through its data input 422 and dynamically adjusts the output voltage 414 of the AVR 410 accordingly to improve the power efficiency of the system 400.

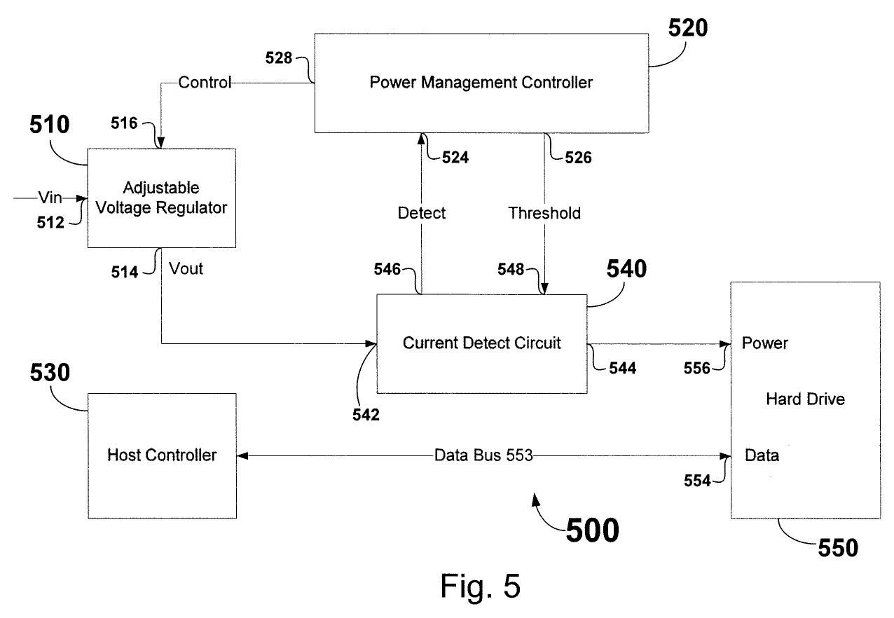

FIG. 5 illustrates a system 500 for voltage scaling of a hard drive to reduce power consumption according to one embodiment of the present invention. The system 500 includes an adjustable voltage regulator (AVR) 510, a host controller 530, a power management controller (PMC) 520, a current detect circuit 540, and a hard drive 550. The PMC 520 includes a current detect input 524, a threshold output 526, and a control output 528. The hard drive 550 includes a data port 554 and a power input 556. The current detect circuit 540 includes a power input 542, a power output 544, a detect output 546, and a threshold input 548. The AVR 510 includes a voltage input 512, an adjustable voltage output 514, and a control input 516. The electrical connections between the above components are similar to that of FIG. 3, except where there is no direct electrical connection between the host controller 530 and the PMC 520.

The current detect circuit 540 may be located inside or outside of the hard drive 550. In some embodiments, the current detect circuit 540 may be part of the AVR 510. Alternatively, the current detect circuit 540 may be on the same IC as the PMC 520, or on a separate IC as the PMC 520. Furthermore, the PMC 520 may be located inside or outside of the hard drive 550. The AVR 510 may be located inside or outside of the hard drive 550 or on the same or separate IC as the PMC 520. Other physical locations of the current detect circuit 540, the AVR 510, and the PMC 520 may be utilized.

In one embodiment, the PMC 520 does not receive control data from the host controller 530. The PMC 520 relies on the current detect data from the current detect circuit 540 to dynamically adjust the output voltage 514 of the AVR 510. In other words, the PMC 520 dynamically adjusts the output voltage 514 of the AVR 510 based solely on the current detect data without taking into consideration the communication on the data bus 553 between the host controller 530 and the hard drive 550.

In an alternative embodiment, the current detection circuit 540 may be replaced by a timer if the high current events normally detected by the current detection circuit occur at predictable points in time. Additionally, if the PMC 520 is integrated into the hard drive 550 directly, and additional information regarding the operating state of the hard drive 550 is available to the PMC 520, the current detection and/or communication detection circuits may not be necessary.

FIG. 6 illustrates an embodiment of a threshold comparator 600 to determine when the current draw of a hard drive 650 exceeds a programmable threshold 664. The threshold comparator 600 includes a sense resistor (Rsense) 620, a differential filter 670, a differential amplifier with gain 640, and a voltage comparator 660. Additionally, the threshold comparator 600 is interfaced to the adjustable voltage output 615 of the AVR 610 and to the power input 656 of the hard drive 650. The hard drive 650 has a power input 656 and an electrically grounded return path. The AVR 610 has a voltage input 613, a voltage output 615, a control input 617, and an electrically grounded return path.

In one embodiment, the input of the AVR 610 may be the control output 328 of the PMC 320 as depicted in FIG. 3. The AVR 610 output voltage 615 is in electrical connection with both Rsense 620 and the positive input of the differential filter 670. The opposite end of Rsense 620 is in electrical connection with both the power input 656 of the hard drive 650 and the negative input of the differential filter 670. The output of the differential filter 670 is in electrical connection with the differential input of the differential amplifier 640. The output of the differential amplifier 640 is connected to the positive input of voltage comparator 660. A threshold reference voltage 664 is applied to the negative input of the voltage comparator 660. The threshold reference voltage 664 is typically provided by the PMC 320 via the threshold output 326. The output of voltage comparator 660 is connected to the current detect input 324 of the PMC 320 according to the embodiment of FIG. 3.

In operation, the AVR 610 provides power to the hard drive 650. The voltage output 615 of the AVR 610 is dynamically adjusted in accordance to the amount of current 625 (hereinafter “Id 625”) drawn by the hard drive 650. Id 625 passes through Rsense 620, which then develops a voltage across its terminals. This voltage is differentially filtered by filter 670 to remove unwanted noise before being differentially applied to the differential amplifier 640. The output of the differential amplifier 640 is typically the voltage across Rsense 620 multiplied by a programmable gain value. The gain value is the amount of amplification that the differential amplifier 640 provides to its differential input signals. In one embodiment, the gain of the differential amplifier 640 may be set through peripheral component selection. The differential amplifier 640 may include a variety of electronic components, such as operational amplifiers, ICs, discrete components, etc.

The output of the differential amplifier 640 feeds into the positive input of the comparator circuit 660. A threshold voltage 664 is applied to the negative terminal of the comparator circuit 660. For example, this threshold voltage 664 may be supplied by a PMC (e.g., the PMC 320 in FIG. 3) and may be fully programmable. The comparator circuit 660 provides a logic output high or low depending on the relationship between the signals at its differential input. For example, in one embodiment, a logic high output may result if the current Id 625 multiplied by the resistance of Rsense 620 and the gain of the differential amplifier 640 is greater than the programmable threshold voltage 664. The logic output (a.k.a. current detect signal) 662 of the comparator circuit 660 feeds into the PMC. The PMC adjusts the output voltage 615 of AVR 610 accordingly via the control input 617, thereby improving the power efficiency of the system.

The voltage comparator 660 may be implemented using discrete components, integrated circuits, etc. Other current detection circuits may also be used to allow the PMC to differentiate different modes of operation in different embodiments.

FIG. 7 illustrates one embodiment of a state diagram 700 of a state machine usable in some embodiments of the PMCs discussed above. The state machine includes two states: a steady state 710 and a non-steady state 720. Because of the small number of states, the state machine is better utilized for applications that require simplicity of operation and ease of implementation.

The steady state 710 includes the following modes of operation of a hard drive (e.g., the hard drive 350 in FIG. 3): when the hard drive is in the active, idle, standby, or sleep modes; when there is no high power event of the hard drive; when there is no pertinent communication between the hard drive and the host controller; and no access of the host controller or the platter.

In one embodiment, the non-steady state 720 includes: spinning up the spindle; the loading and unloading of the heads; communication between the hard drive and the host controller; the host controller accessing the platter if the heads are loaded; and any high power event of the hard drive.

In one embodiment, the state machine transitions from the non-steady state 720 to the steady state 710 in response to a timeout 701. A timeout 701 event occurs when a data or current event has not been detected for a specified amount of time. The period of the timeout is chosen so as to not prematurely transition from the non-steady state 720 to the steady state 710 in the event that data or current event signals are not constant due to noise or other aberration. Likewise, the timeout period should be sufficiently short so as to ensure a transition from the non-steady state 720 to the steady state 710 in a reasonable amount time after all detected current and data events have come to completion. In one embodiment, the state machine transitions from the steady state 710 to the non-steady state 720 in response to detection of certain data. For example, the data may include a read or a write event detected on a data bus (e.g., an Advanced Technology Attachment (ATA) bus) connecting the hard drive to the host controller. Alternatively, when the current draw of the hard drive has exceeded a predetermined threshold (which may be determined as discussed above with reference to FIG. 6), the state machine may also transition from the non-steady state 720 to the steady state 710. The steady state 710 and the non-steady state 720 are associated with supply voltages V1 and V2, respectively. In one embodiment, supply voltage V1 is greater than or equal to supply voltage V2.

In some embodiments, the PMC directs the AVR to increase the input supply voltage of the hard drive such that high current events in the hard drive do not cause a brownout of the power supply while the state machine 700 is in the non-steady state 720. The PMC also adjusts the input supply voltage of the hard drive to ensure that there are adequate noise margins for communication between the hard drive and the host controller as well as any internal communication within the hard drive. While in the steady state 710, the PMC may instruct the AVR to decrease the input supply voltage of the hard drive such that the power consumption of the hard drive is reduced.

In some embodiments, a time delay is added to the transition from the non-steady state 720 to the steady state 710. The time delay may prevent a transition to the steady state 710 when the requirements for transition are only valid for a short period of time. The power loss associated with changing states and supply voltages may be greater than the power lost by remaining in the non-steady state 720 for a longer period of time than required by the high power event. The length of the time delay may be chosen to balance power savings and latency. The time delay may be calculated using a deterministic or probabilistic lower envelope algorithm.

FIG. 8 illustrates one embodiment of a state diagram 800 of a state machine usable in some embodiments of the PMCs described above to improve power efficiency of hard drives. The state machine includes four states: reset state 810, startup state 830, active state 840, and standby state 820. There are two timeout events: timeout 801 and 802. In addition, there are two current detect thresholds: current 1 and current 2.

In one embodiment, the state machine enters reset state 810 before power is applied to the hard drive. Startup state 830 any high power hard drive events such as platter spin up and the unloading of the heads. Active state 840 is for medium power hard drive events which could include platter access or communication between the host controller and the hard drive. Standby state 820 is for low power hard drive events such as when the hard drive is in standby, the platters are not spinning, or the platters are not being accessed, etc. The timeouts 801 and 802 may be chosen such that there is not a premature state transition due to noise or other aberration affecting the current 1, current 2, and data signals. In addition, the timeouts 801 and 802 may be chosen such that the energy consumption of the hard drive is reduced. The timeout lengths may be calculated using a lower envelope algorithm. In some embodiments, states 820, 830, and 840 are associated with AVR output voltages V3, V1, and V2, respectively. For example, a supply voltage of V3 may be provided to the hard drive when the state machine is in standby state 820, a supply voltage of V1 may be provided to the hard drive when the state machine is in startup state 830, etc. In some embodiments, supply voltage V1 is greater than or equal to supply voltage V2, and V2 is greater than or equal to supply voltage V3. In one embodiment, the state machine transitions from standby state 820 to startup state 830 in response to detection of data or a current draw that exceeds the current 1 threshold. The state machine remains in startup state 830 in response to detection of a current that exceeds the current 1 threshold. The state machine transitions from startup state 830 to active state 840 in response to timeout 801. The state machine remains in active state 840 in response to detection of a hard drive current draw that exceeds the current 2 threshold or data detection. The state machine transitions from active state 840 to startup state 830 in response to detection of a hard drive current draw that exceeds the current 1 threshold. The state machine transitions from active state 840 to standby state 820 in response to timeout 802. The state machine transitions from the standby state 820 to the active state 840 in response to the detection of a hard drive current draw that exceeds the current 2 threshold. As used above, the term “data” refers to a read or write event detected on a data bus (e.g., an ATA bus). Current 1 of state machine occurs when the current draw of the hard drive is greater than a current 1 threshold. This threshold is set to trip on hard drive platter spin-up and on the unloading of the hard drive heads. Current 2 occurs when the current draw of the hard drive is greater than a current 2 threshold. This threshold is set to trip when the hard drive platters are spinning up, the heads are being unloaded, or the platters are being accessed. In some embodiments, the current 1 threshold is greater than the current 2 threshold. For example, the current draw of the hard drive will be greater than the current 2 threshold be less than the current 1 threshold when the hard drive platters are being accessed.

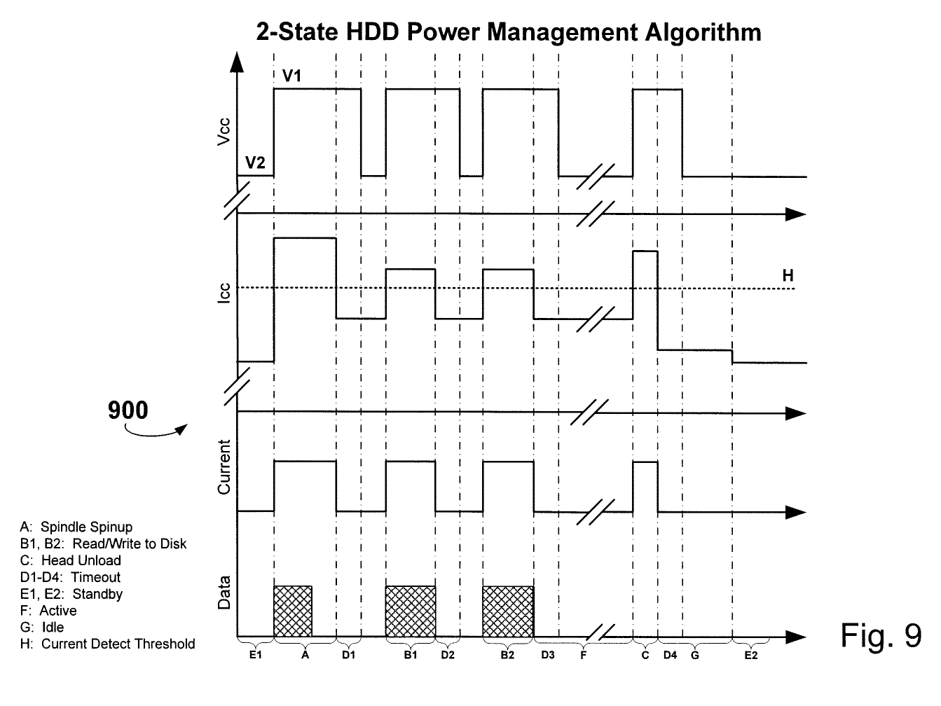

FIG. 9 illustrates one embodiment of a timing diagram related to the state machine of the state diagram illustrated in FIG. 7. During the period before time A of timing diagram, the state machine 700 is in the standby state at voltage level V2 (as shown in FIG. 7), where no data or current control signals are detected. During period A, both current and data are detected and the state machine enters a spindle spin up and head load phase, prompting the hard drive to draw a high enough current from the AVR to trip the current detect threshold (denoted by ‘H’ in the timing diagram). This changes the AVR output voltage to V1 and the state machine 700 enters the Non-Steady State 720.

During period D1, no current or data is detected. After a predetermined period, the timeout 701 is met and the state machine 700 returns to the Steady State 710 with the AVR output voltage set to V2. The state machine remains in Steady State 710 until data or current is detected by the PMC. During period B1, the hard drive enters a Read/Write-to-Disk phase and both current and data are detected by the PMC. B1 prompts the hard drive to draw a high enough current from the AVR to trip the current detect threshold, thereby returning the state machine 700 to the Non-Steady State 720 with the AVR output voltage set to V1. During period D2, no current or data is detected. After a predetermined period, the timeout 701 is met and the state machine 700 returns to the Steady State 710 with the AVR output voltage set to V2. The state machine remains in Steady State 710 until data or current is detected by the PMC. The analysis for periods B2 and D3 are similar to that of B1 and D2.

During period F, the state machine 700 remains in the steady state 710 during an active period where no current or data is detected. At period C, the hard drive enters a head unload phase. Enough current is drawn to trip the current detect threshold and the State Machine enters the Non-Steady State 720 with the AVR output voltage set to V1. For period D4, the analysis is substantially the same as D1. For period G, the Idle period, which includes the timeout period of D4, the State Machine 700 remains in the Steady State 710 with the AVR output voltage set to V2. During period E2, the standby state, the analysis is similar to E1. Note that the timing diagram in FIG. 9 is shown for the purpose of illustrating one example of how various parameters of the hard drive may correspond to different state transitions. Other embodiments of the state machine may include different states.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features, which come within the spirit and scope of the invention.

It should be appreciated that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention. In addition, while the invention has been described in terms of several embodiments, those skilled in the art will recognize that the invention is not limited to the embodiments described. The embodiments of the invention can be practiced with modification and alteration within the scope of the appended claims. The specification and the drawings are thus to be regarded as illustrative instead of limiting on the invention.

What is claimed is:

1. An apparatus comprising:
a parameter detection circuit coupled to an electric motor load to detect one or more parameters of said electric motor load; and
a power management controller coupled to said parameter detection circuit to receive said one or more parameters and to scale a voltage supply to said electric motor load in response to said one or more parameters.

2. The apparatus of claim 1, further comprising:
an adjustable voltage regulator coupled to said power management controller to adjust an output voltage in response to control signals from said power management controller.

3. The apparatus of claim 1, wherein said power management controller comprises: a circuit to monitor data on a data bus coupling said electric motor load and a host controller of said electric motor load.

4. The apparatus of claim 1, wherein said parameter detection circuit comprises:
a current detection circuit to monitor current drawn by said electric motor load.

5. The apparatus of claim 4, wherein said current detection circuit comprises:
a resistor coupled between the electrically motorized device and the voltage supply; and
a voltage comparator to compare a voltage across the resistor against a threshold voltage and to output a current detect signal based on result of comparing the voltage across the resistor and the threshold voltage.

6. The apparatus of claim 1, wherein said parameter detect circuit comprises:
a temperature detection circuit to monitor said temperature of said electric load.

7. The apparatus of claim 1, wherein the power management controller comprises:
a state machine to transition between a plurality of states in response to the one or more parameters detected by the parameter detect circuit, wherein the plurality of states are associated with a plurality of operation states of the electrically motorized device.

8. The apparatus of claim 1, wherein said electric motor load comprises an electrical media storage device.

9. The apparatus of claim 8, wherein said electrical media storage device comprises a hard drive.

10. A method comprising:
detecting one or more parameters of an electrical motor load; and
scaling a voltage supply to the electrical motor load in response to the one or more parameters detected.

11. The method of claim 10, further comprising:
defining a plurality of states, each of the plurality of states associated with an operation state of the electrical motor load.

12. The method of claim 11, further comprising:
transitioning between the plurality of states in response to the one or more parameters.

13. The method of claim 11, further comprising:
transitioning between the plurality of states in response to a timeout.

14. The method of claim 10, wherein detecting the one or more parameters comprises:
sensing a current drawn by the electrical motor load.

15. The method of claim 10, wherein detecting the one or more parameters comprises:
sensing a temperature of the electrical motor load.

16. The method of claim 10, wherein detecting the one or more parameters comprises:
sensing an ambient temperature near the electrical motor load.

17. The method of claim 10, wherein the electrical motor load comprises a data
storage device, and detecting the one or more parameters further comprises:
monitoring communication between the data storage device and a host controller of the electrical motor load on a data bus coupling the data storage device to the host controller.

18. An apparatus comprising:
means for determining a state of an electric motor load; and
means for scaling a voltage supply to the electric motor load based on the state determined.

19. The apparatus of claim 18, further comprising:
means for detecting one or more parameters of the electric motor load.

20. The apparatus of claim 19, wherein the means for determining the state of the electric motor load comprises means for determining the state based on the one or more parameters detected.
